(19) United States
(12) Patent Application Publication
(10) Pub. No.: US 2011/0002498 A1
(43) Pub. Date: Jan. 6, 2011

(54) IN-EAR HEADPHONE AND HEADSET

(75) Inventors: Yuen Shen Wong, Singapore (SG); Chee Keong Tan, Singapore (SG)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Sennheiser electronic GmbH & Co., KG, Wedemark (DE)

(21) Appl. No.: 12/747,144

(22) PCT Filed: Dec. 15, 2008
(86) PCT No.: PCT/EP2008/010629

§ 371 Date: Sep. 20, 2010

(30) Foreign Application Priority Data
Dec. 14, 2007 (DE) 20 2007 017 468.3

(51) Int. Cl. H04R 1/10

(52) U.S. Cl. 381/380

(57) ABSTRACT

There is provided an in-ear earphone comprising a housing (100), a transducer housing (200) and a support unit (300). The transducer housing (200) serves to receive an electroacoustic transducer. The support unit (300) is connected to the housing (100) and is adapted to be anchored in a concha of a wearer. The support unit (300) is at least partially made from a soft flexible material. In that way it can be ensured that the in-ear earphone can be anchored in any concha of a wearer.

The present invention concerns an earphone and in particular an in-ear earphone.

DE 439808 discloses a headphone with a headphone band and two arcuate pressure pads which bear against the temples of a wearer. The headphone further has two earpieces which bear against the ears of a wearer.

DE 20 2006 008 508 discloses an in-ear earphone having an electroacoustic transducer and a support element coupled to the transducer. In that case the transducer forms a first point of an anchorage and the support element forms a second point of an anchorage so that two-point anchorage in the outer ear is made possible.

DE 40 19 250 discloses an intra-conchal electroacoustic transducer with an auxiliary support device.

U.S. Pat. No. 5,935,435 discloses an in-ear earphone with a support element which is displaceable along the in-ear earphone and which can engage into an outer ear of a wearer.

KR 10-2006-0113603 discloses an in-ear earphone with a support element which can engage into an outer ear of a user.

DE 10 2004 010 198 A1 discloses an in-ear earphone having at least one electroacoustic transducer and a support element. The support element is coupled to the transducer. The transducer forms a first point of an anchorage and the support element forms a second point of an anchorage so that it is possible to achieve a two-point anchorage in the outer ear. The support element is biased in relation to the transducer.

An object of the present invention is to provide an in-ear earphone and a headset which has improved wearing comfort.

That object is attained by an earphone according to claim 1 and a headset according to claim 5.

Thus there is provided an in-ear earphone comprising a housing, a transducer housing and a support unit. The transducer housing serves to receive an electroacoustic transducer. The support unit is connected to the housing and is adapted to be anchored in a concha of a wearer. The support unit is at least partially made from a soft flexible material. In that way it can be ensured that the in-ear earphone can be anchored in any concha of a wearer.

In accordance with an aspect of the present invention the support unit is fixed rotatably and/or pivotably to an end of the housing.

In accordance with a further aspect of the invention the support unit is connected to the first end of the housing by way of a ball joint.

The invention also concerns a headset having at least one housing, a transducer housing and a support unit. The transducer housing serves to receive an electroacoustic reproduction transducer. The support unit is connected to the housing and is adapted to be anchored in a concha of a wearer. The support unit is at least partially made from a soft flexible material. It can thus be ensured that the headset can be anchored in any concha of a wearer.

Further aspects of the invention are subject-matter of the appendant claims.

Embodiments by way of example and advantages of the present invention are described in greater detail hereinafter with reference to the drawing.

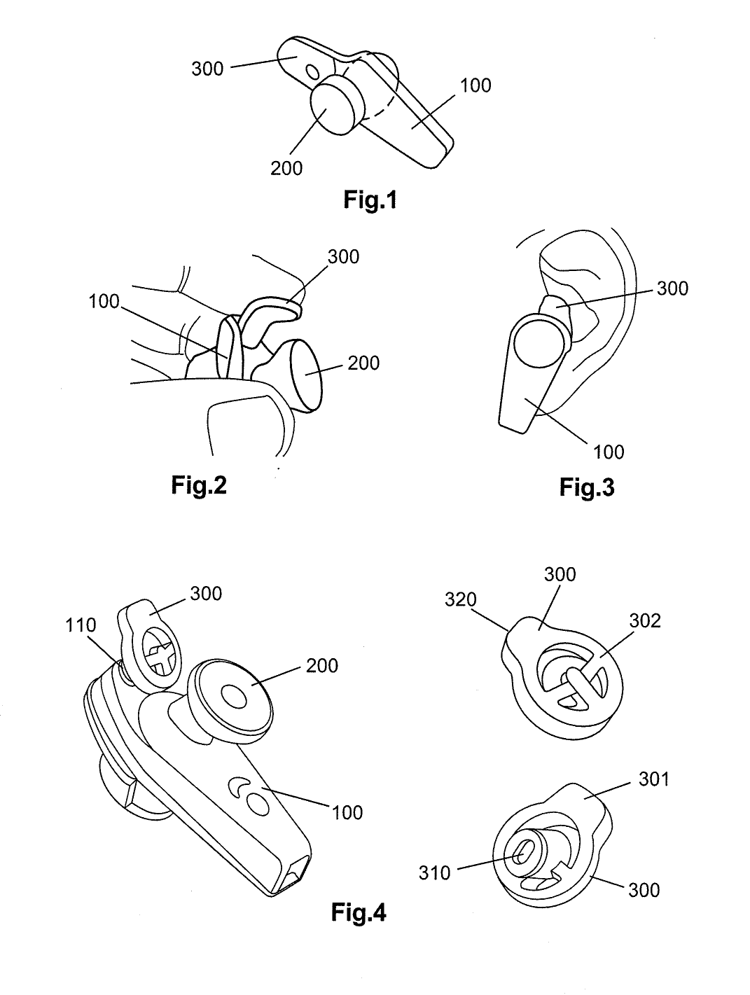

FIG. 1 shows a diagrammatic view of an in-ear earphone according to a first embodiment,

FIG. 2 shows a further diagrammatic view of an in-ear earphone according to the first embodiment,

FIG. 3 shows still a further diagrammatic view of an in-ear earphone according to the first embodiment, and

FIG. 4 shows a diagrammatic view of an in-ear earphone according to a second embodiment.

FIG. 1 shows a diagrammatic view of an in-ear earphone according to a first embodiment. The in-ear earphone has a housing 100, a transducer housing 200 for receiving an electroacoustic transducer and a support element 300. The support element 300 can be removably fixed at the upper end of the housing. The support element 300 is preferably flexible and can be of a soft flexible material.

FIG. 2 shows a further diagrammatic view of the in-ear earphone according to the first embodiment. It can be clearly seen from FIG. 2 that the support element 300 is flexible. The support element 300 is preferably made from a soft elastic material such as for example rubber so that the support element can be inserted into the concha of a wearer to ensure a secure fit of the in-ear earphone (see FIG. 3). The flexible configuration of the support element 300 in accordance with the first embodiment can provide that the in-ear earphone can be fitted into any ear. Thus there is provided an in-ear earphone involving a one-size-fit-all solution, that is to say the in-ear earphone in accordance with the first embodiment can be fitted into or to any ear or outer ear.

FIG. 4 shows a diagrammatic view of an in-ear earphone in accordance with a second embodiment. The in-ear earphone in the second embodiment also has a housing 100, a transducer housing 200 for receiving an electroacoustic transducer and a support element 300. The support element is provided at an end 110 of the housing 100.

The support element 300 has a first end 301 serving to be inserted into the concha of an outer ear. The support element 300 also has an opening or recess 310 by means of which the support element can be rotatably and/or pivotably fixed at the first end 110.

The support element can be fixed by means of a ball joint at the first end 110 of the housing 100. In that way it can be provided that the support element 300 is fixed movably at the first end 110 of the housing, which improves wearing comfort and adaptability.

The support element 300 in the second embodiment can be made from a soft flexible material.

A wireless receiving unit can be provided in the housing 100 of the first and second embodiments so that audio signals are wirelessly transmitted to the in-ear earphone. That wireless communication can be based for example on the Bluetooth protocol, the WLAN protocol or other wireless protocols.

In the earphone in accordance with the first and second embodiments the transducer housing 200 is disposed in a first plane spaced from a second plane in which the housing and/or the support element is disposed.

In accordance with a further embodiment of the invention there is provided a headset based on the in-ear earphone in accordance with the first or second embodiment. A microphone must be provided in the in-ear earphone to implement a headset. If the headset is wireless the speech signals recorded by the microphone must be transmitted wirelessly by means of a transmitting unit. In such a case the wireless headset can have a wireless transmitting/receiving unit.

1. An in-ear earphone comprising:
a housing,
a transducer housing for receiving an electroacoustic transducer, and
a support unit connected to the housing and adapted to be anchored in a concha of a wearer,
wherein the support unit at least partially has a soft flexible material.

2. An earphone according to claim 1 wherein the support unit is rotatably and/or pivotably fixed at an end of the housing.

3. An earphone according to claim 1 wherein the support unit is connected by way of a ball joint to the first end of the housing.

4. An earphone according to claim 1 wherein the transducer housing is disposed in a first plane and the support unit is disposed in a second plane, the first plane being spaced relative to the second plane.

5. A headset comprising:
at least one housing,
a transducer housing for receiving an electroacoustic transducer, and
a support unit connected to the housing and adapted to be anchored in a concha of a wearer,
wherein the support unit at least partially has a flexible material.

6. A headset according to claim 5 wherein the support unit is rotatably and/or pivotably fixed at an end of the housing.
